(19) United States
(12) Patent Application Publication
(10) Pub. No.: US 2010/0231391 A1
(43) Pub. Date: Sep. 16, 2010

(54) SYSTEM AND METHOD FOR HUMAN DOG COMMUNICATION

(76) Inventors: Jonathan Sinai DROR, Tel Aviv (IL); Harel TODER, Herzelia (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/402,531

(22) Filed: Mar. 12, 2009

(51) Int. Cl. G08B 23/00

(52) U.S. Cl. 340/573.3

(57) ABSTRACT

It is disclosed a device for issuing signals reflecting a state of an autonomous carrier, a dog for example. The device includes sensors, signal generators like a loudspeaker or a light source, and a processor. The sensors are adapted for sensing parameters of the carrier and for issuing outputs in accordance with the sensed parameters. The signal generators are adapted for issuing signals sensible by humans. The processor is adapted for receiving the outputs and for triggering issue of the signals by the signal generators in accordance with the received outputs. One of the sensors senses visible parameters of the animal, like a global positioning system (GPS) sensor, a tilt sensor, an acceleration meter, and a proximity sensing article. One of the sensor senses invisible parameters of that living carrier, like a temperature meter, a respiration monitor, a pulse rate meter, a skin humidity sensor, and a sniffer. Certain states of the carrier are determined by certain location of the carrier, certain posture of the carrier relative to ground, and/or having invisible parameter within certain value range. The device includes a state database configured for containing a plurality of data items associated with determination of a state of the carrier.

### BACKGROUND OF THE INVENTION

1. Field of the Invention

The invention is in the fields of equipment for pets, pet games and devices for enriching the pet ownership experience. In particular, the disclosed invention deals with human dog communication.

2. Description of Related Art

The statement “the dog is the man's best friend” reflects the feelings of a lot of dog's owners. The interaction between a dog and the owner is based on each side learning the other side behavior and signals and responding according to those signals. For example, a person putting on walking shoes may signal a dog that he intends to take a walk, as he does quite often, taking the dog with him. In response, the dog may approach the door and move impatiently from side to side signaling the owner how much he would like to go outside. Such an interaction may be very important for the owner, providing him a kind of socialization.

The passion for communication with the dog expresses itself by a human habit to talk to a dog, with the dog responding by barking but being unable to respond verbally or in other form which is richer in content than merely barking. The desire for such a verbal response is expressed in numerous fiction and movies which present talking animals, dogs especially.

Thus, there is a need for a method or a device to facilitate verbal or vocal signaling which seems to originate in a dog, reflecting his state.

### BRIEF SUMMARY OF THE INVENTION

It is disclosed for the first time, a device for issuing signals reflecting a state of an autonomous carrier which carry the device. The carrier is autonomic in motion, and the device includes sensors, signal generators, and a processor. The sensors are adapted for sensing parameters of the carrier and for issuing outputs in accordance with the sensed parameters. The signal generators are adapted for issuing signals sensible by humans. The processor is adapted for receiving the outputs and for triggering issue of the signals by the signal generators in accordance with the received outputs.

In some embodiments, the device is autonomous in ground motion.

In some embodiments, the carrier is a pet animal.

In some embodiments, one of the sensors senses visible parameters of the animal. Exemplary sensors are a global positioning system (GPS) sensor, a tilt sensor, an acceleration meter, and a proximity sensing article.

In some embodiments, the carrier is a living carrier, and one of the sensor senses invisible parameters of that living carrier. Exemplary sensors are a temperature meter adapted to measure the body temperature of the living carrier, a temperature meter adapted to measure the air temperature proximate to the living carrier, a respiration monitor of the living carrier, a pulse rate meter of the living carrier, a skin humidity sensor of the living carrier, a sniffer, and a blood pressure meter.

In some embodiments, certain states of the carrier are determined by certain location of the carrier, certain posture of the carrier relative to ground, and/or having invisible parameter within certain value range.

Exemplary signal generators are a loudspeaker and a light source.

In some embodiments, the device includes a voice recognition module.

In some embodiments, the device includes a state database configured for containing a plurality of data items associated with determination of a state of the carrier. The state affects the signal issued by a signal generator.

In some embodiments, the device includes a signal database configured for containing a plurality of signals, wherein each signal may be issued by a signal generator. The signals may be determined by a state attributed to the carrier by the processor.

In some embodiments, the device includes a button interface adapted for manual programming of the device.

In some embodiments, the device includes a communication interface adapted for communicating with an external apparatus.

In some embodiments, the device is adapted to be programmed by an external agent.

It is disclosed for the first time a device for issuing signals reflecting a state of a living carrier. The living carrier carries sensors adapted for sensing invisible parameters of the living carrier and for issuing outputs in accordance with the parameters. The device includes a processor adapted for receiving the outputs, associating a state of the carrier with the outputs, linking the associated state of the living carrier with a signal, and triggering issue of the linked signal by signal generators. The signal generators are adapted for issuing a signal sensible by humans.

It is disclosed for the first time a method for issuing signals reflecting the state of an autonomous carrier. The carrier is autonomic in motion, and the method includes receiving outputs associated with parameters of the carrier, and triggering issue of the signals by the signal generators in accordance with the received outputs.

In some embodiments the method includes the steps of associating a state of the carrier with the outputs, linking the associated state of the carrier with a signal, and issuing the linked signal, wherein the issued signal is sensible by human beings.

A state database and a signal database may be available for facilitating the associating and the linking, respectively. In such a case, the method may support evolving and adaptive system. For that aim the method includes the step of evolving the state database and the signal database with accumulating experience of issuing signals reflecting the state of the carrier.

In some embodiments, the method includes the step of attaching an article to the carrier, wherein the article includes a device for issuing signals reflecting the state of the carrier.

In some embodiments, the method includes the steps of receiving an audio human signal, and associating the received audio signal with a predetermined human content item.

In some embodiments, an issuable signal is selected in accordance with a human vocal signal.

In some embodiments, the method includes the step of receiving programming inputs.

It is provided a program storage device readable by a computerized apparatus, tangibly embodying a program of instructions executable by the computerized apparatus to perform the method for issuing signals reflecting the state of an autonomous carrier.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 illustrates a human-animal communication device attached to a dog collar.

FIG. 2 is a block diagram of a human-animal communication device which includes a variety of sensors.

FIG. 3 is a block diagram of a human-animal communication device linked to a variety of sensors.

FIG. 4 is a flow chart of a method for human-animal communication.

FIG. 5 is a flow chart of a method for human-animal communication having additional steps.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

### DEFINITIONS

Autonomous carrier is an animal or a robotic article having the physical ability and the self control to move from one place to another place in accordance with self drive, without getting continuous and exact directions regarding the motion. For example, a dog walks from one place to another place at home and in the garden, following his natural senses and his drive to look after another dog, to run after a cat, to look for some food, etc. A robotic example may be an automatic lawn mower, left in the lawn to execute its mowing function automatically, moving from one side to another, and changing direction upon approaching an edge.

State of an autonomous carrier is an attribute or a set of attributes associated with the carrier. For example, a location state is associated with the present location and/or posture of the carrier. Presumably, a dog standing on his/her back feet near a dinner table is in a hungry state.

A signal which is sensible by humans and reflects a state is a message that a human being may sense directly, and which describes, or is associated with a state of the autonomous carrier. For example, a verbal declaration “I am hungry” may be associated with the aforesaid location state of a dog standing near a dinner table.

### FIRST EMBODIMENT

### A Collar Human-Animal Communication Device

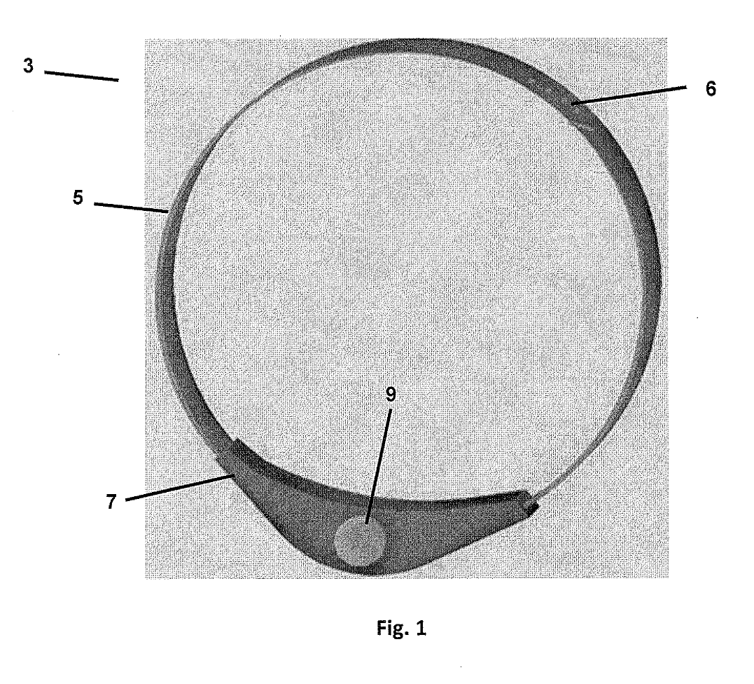

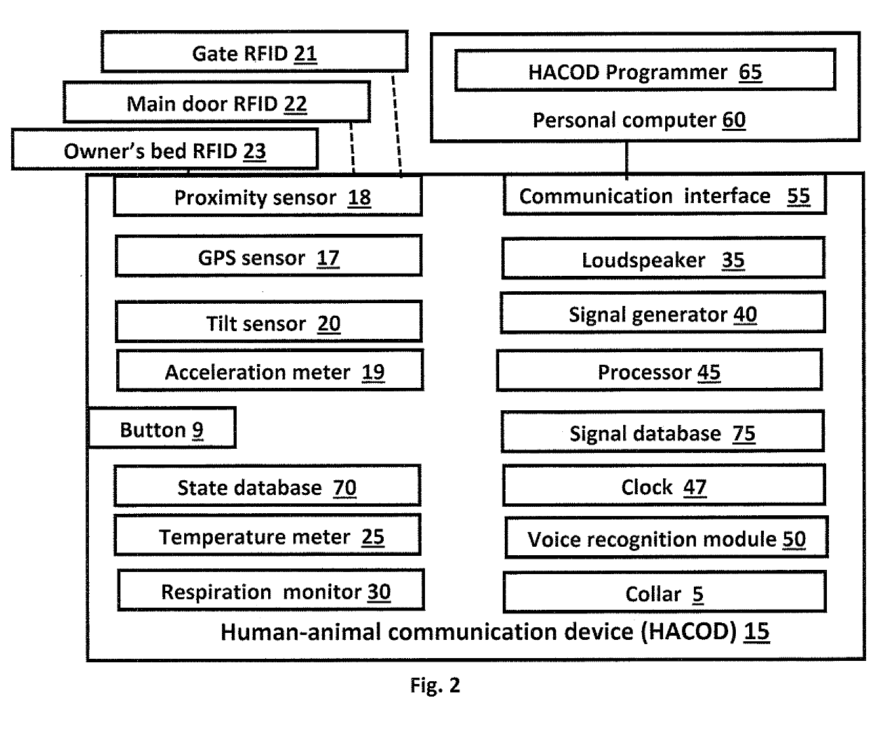

FIG. 1 illustrates a collar human-animal communication device (HACOD) 3. The device 3 includes a collar strap 5 having a fastener 6, and a compartment 7 having a button 9. A dog owner may put the collar on the dog neck and the device issues signals reflecting a state of the dog. The compartment 7 includes a variety of electronic and electrical components as described in the block diagram of FIG. 2.

The device 3 may include sensors 17-19, signal generators 35 and 40, a processor 45 and means for attaching the device to the carrier, like collar 5. The sensors are adapted for sensing parameters of the carrier and for issuing outputs in accordance with the sensed parameters. The signal generators are adapted for issuing signals sensible by humans. For example, loudspeaker 35 may emit a recorded vocal message. The processor 45 is adapted for receiving the outputs, associating a state of the carrier with the outputs, linking the associated state of the carrier with a signal, and triggering issue of the linked signal by loudspeaker 35 and/or signal generator 40.

In the embodiment of FIG. 2 several sensors senses visible parameters of the animal. Exemplary sensors are a global positioning system (GPS) sensor 17, a proximity sensing article 18, an acceleration meter 19, and a tilt sensor 20.

The GPS sensor 17 may sense the location of the dog within the accuracy obtainable by the GPS. Initially, the owner may calibrate the sensor by walking with the device from one place to another, pressing button 9 to feed a code for the location. For example, the directions for operating the device may allocate three consequent pressings of button 9 for the yard gate. Thus, the owner approaches the gate with the dog, and presses the button three consecutive times. Once the dog arrives the gate, the GPS sensor emits an output to the processor 45 indicating that the dog is near the gate, and the processor 45 pulls out a recorded declaration “we are going to a walk” and causes the loudspeaker 35 to issue that declaration.

Alternatively, the operation direction of the device may dictate certain series of locations, and the owner may walk with the device (with or without the dog) from one location to another as dictated, pressing the button once in each location. An exemplary series includes the main door, owner's bed, food bowl, dinner table, etc.

The processor 45 may work in conjunction with two databases, a state database 70 and a signal database 75. The processor 45 may receive the outputs from the sensors and compare them to the data in the state database 70 in order to identify the state. Consequently, the processor pulls out an appropriate signal from signal database 75, sending the signal to an appropriate signal generator. A verbal or vocal recorded signal may be sent to the loudspeaker 35. Serving a deaf owner, the signal may be a series of lights emitted by a light source constituting signal generator 40.

A proximity sensor 18 may be a radio frequency identification (RFID) reader which operates in conjunction with several RFID tags. The owner disposes the tags in various locations prior to operating the proximity sensor, a gate RFID 21, a main door RFID 22 and owner's bed RFID 23, for example. The proximity sensor may has a location accuracy which is finer than the location accuracy available with a GPS sensor 17. On the other hand, the proximity sensor 18 is limited for places wherein an RFID tag has been disposed ahead, while the GPS sensor 17 may be used for a lot more locations spread over unlimited territory.

The acceleration meter 19 may be used for identifying and sorting a variety of activity states, hiking, running, jumping, for example. Outputs from two sensors may be used for identification of certain state. For example, the acceleration meter 19 may issue an output typical for a car starting a journey. At the same time, the GPS sensor 17 issues a series of outputs showing an increasing distance from home. Consequently, the processor 45 analyze those outputs comparing them to data items in the state database 70, determines that the dog is in a commuting car, links that state with a recorded verbal signal residing in the signal database declaring “where are we going?”, and triggers the loudspeaker 35 to issue that vocal signal.

The tilt sensor 20 may be disposed parallel to an imaginary line connecting the dog tail and the dog mouth. Whenever the dog is standing on back feet, probably near the dinner table while the owner family has dinner, the tilt sensor 20 emits an output indicating that state as an hungry state. Accordingly, the processor 45 pulls out of memory a recorded declaration “I am so hungry” and causes the loudspeaker to issue that signaling declaration. Also, a tilt sensor 20 may be attached to a back part of the body, facilitating the identification of an urination state, for example.

The device may include a clock 47 used to ensure that the issued signals are spaced in time, preventing frequent signaling by the device. Programming the device to have a predetermined time duration between signals, as well as for determination of other parameters of the device may be done from an external personal computer 60. A special HACOD programmer 65 may be installed in the computer to enable the owner to program the device in a friendly way. A communication interface 55 may be included in the HACOD 3 to facilitate the communication between with the computer 60 hosting the programmer 65. The communication interface may be a wired element, universal serial bus (USB) terminal, for example. Alternatively, it may be a wireless terminal, Bluetooth, for example.

In some embodiments, one of the sensor senses invisible parameters of that living carrier. Exemplary sensors are a temperature meter 25 adapted to measure the body temperature of the living carrier, or to measure the air temperature proximate to the living carrier, a respiration monitor 30 of the living carrier, a blood pressure meter 31, a sniffer 32, a skin humidity sensor 33, and a pulse rate meter 34 of the living carrier. A state may be determined in accordance with a sensor reading. The range of sensor reading may be divided to several ranges. A first state may be associated with a reading at the first range, a second state may be associated with a reading at the second range, etc. For example, the reading of a pulse rate meter may be divided to low range, up to 15% below normal pulse rate, normal range at ±15% of normal pulse rate, and high range above the normal range. Once the dog is in the low pulse rate and located in his regular sleeping place, as shown by a the output of the proximity sensor 18, the device may issue a series of three yawn signals.

It is possible to program the device to issue the “I am so hungry” signal only on case that a respiration monitor 30 and a pulse rate meter 34 provide outputs that support the assumption that the dog state is actually “standing near a dinner table waiting for food”.

In some embodiments, the device includes a voice recognition module 50. That module may facilitate the identification of a family member talking with the dog. Based on such an identification the processor 45 may trigger a signal which may be unique for each family member. For example, a verbal signal may include the name of the identified family member, i.e. “John, I am so hungry”.

### SECOND EMBODIMENT

### A Human-Animal Communication Device Having Wireless Connection with Sensors Carried by a Carrier

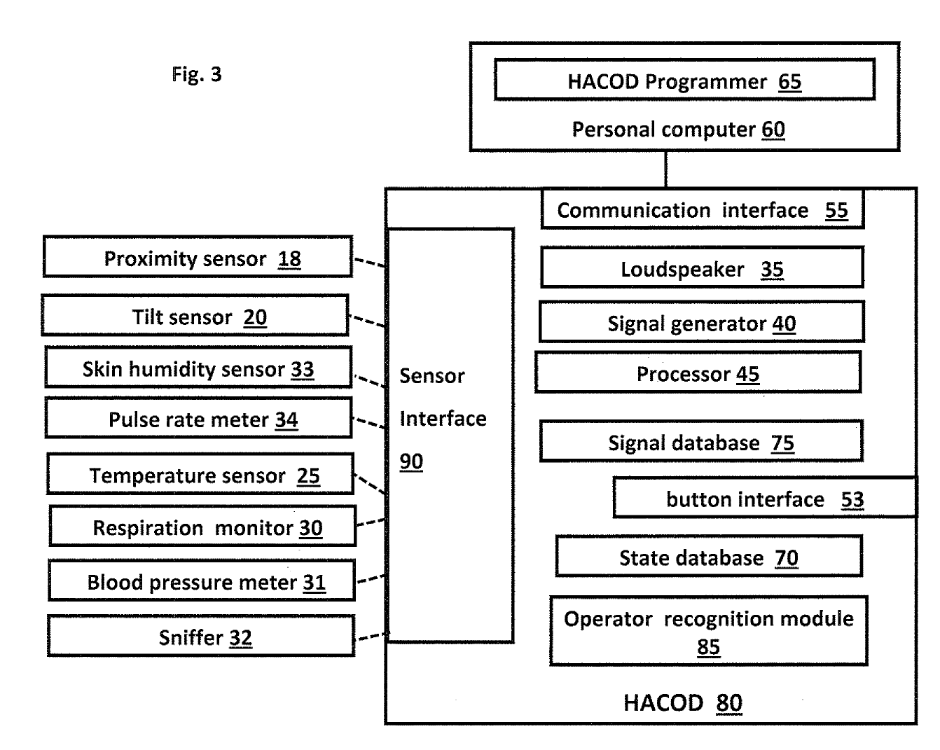

FIG. 3 shows a block diagram of a HACOD 80 having wireless connection with sensors carried by a living carrier. The device 80 issues signals reflecting a state of the living carrier. The living carrier carries sensors adapted for sensing invisible parameters of the living carrier and for issuing outputs in accordance with the parameters. Exemplary sensors are skin humidity sensor 33, pulse rate meter 34, temperature sensor 25, respiration monitor 30, blood pressure meter 31 and sniffer 32. The device 80 includes a processor adapted for receiving the outputs, associating a state of the carrier with the outputs, linking the associated state of the living carrier with a signal, and triggering issue of the linked signal by signal generators 35 and 40. The sensor output is delivered to the HACOD 80 using a wireless connection. Exemplary wireless technologies which are used to communicate the sensors with the HACOD are Bluetooth and Wi-Fi. The HACOD 80 includes a sensor interface 90 to facilitate that connection.

The signal generators 35 and 40 may be part of HACOD 80, wired to HACOD 80 or connected to HACOD 80 wirelessly.

HACOD 80 may include an operator recognition module 85 which enable identification of a person operating the device, such that the signal issued by the signal generator 40 is tailored to fit the person currently using the device 80.

### THIRD EMBODIMENT

### A Method for Human-Animal Communication

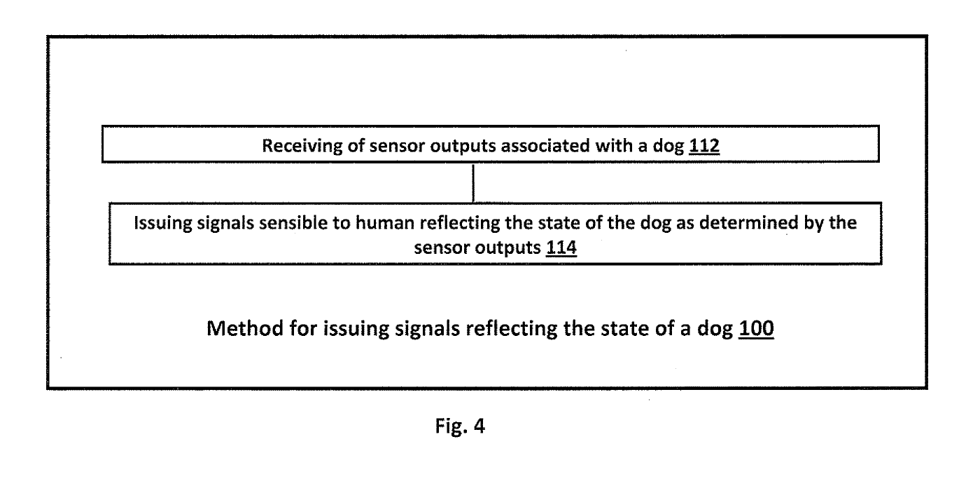

FIG. 4 presents a flow chart of a method 100 for issuing signals reflecting the state of an autonomous carrier. The method 100 includes the step of receiving 112 of sensor outputs associated with a dog, and issuing 114 signals sensible to human and reflecting the state of the dog as determined by the sensor outputs.

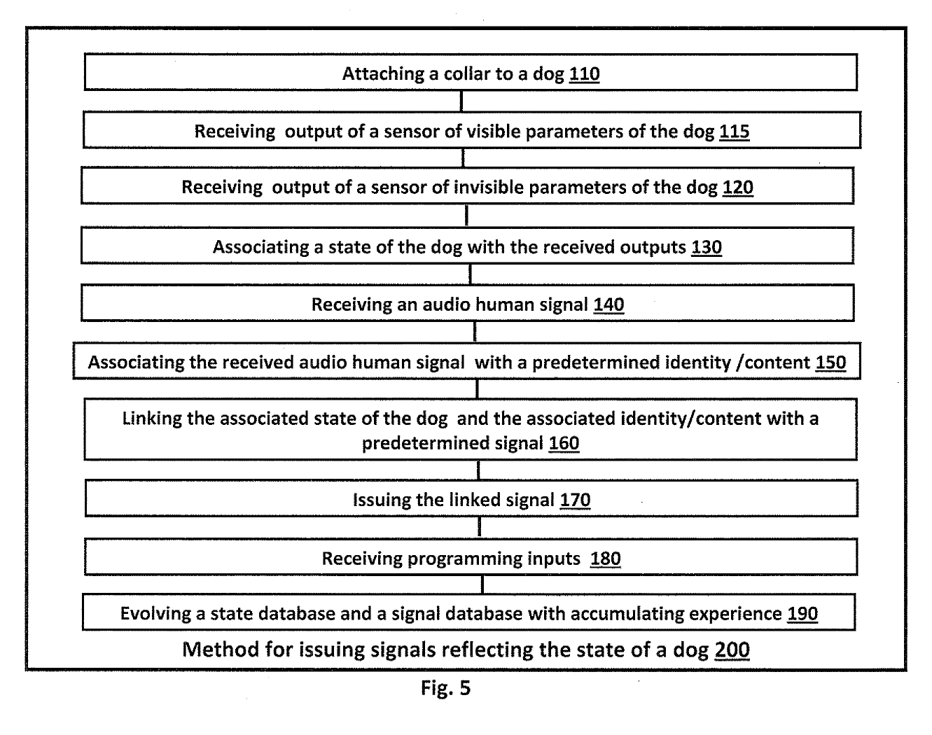

A method for issuing signals reflecting the state of the dog may include additional steps as shown in FIG. 5 for method 200. Steps of method 200 may be performed in any order or simultaneously, unless it is clear from the context that one step depends on another being performed first. Thus, method 200 includes receiving 115 and 120, respectively, outputs associated with visible and invisible parameters of the dog, associating 130 a state of the carrier with the received outputs, linking 160 the associated state of the carrier with a signal, and issuing the linked signal 170. The issued signal is sensible by human beings.

In some embodiments, the method 200 includes the step of attaching 110 an article to the carrier, wherein the article includes a device for issuing signals reflecting the state of the carrier.

In some embodiments, the method 200 includes the steps of receiving 140 a audio human signal, and associating 150 the received audio signal with a predetermined human content item. The linked signal may be associated with the state of the carrier and with the predetermined human content item. The human content item may be the identity of the speaker, and correspondingly, the linked signal includes the name of the identified person. Besides, it is possible to have a database of phrases or words that may be identified and trigger a corresponding signal or affect the selection of an appropriate signal. For example, the human signal “you are a good dog!” may trigger the verbal doggy signal “thanks”. In conjunction with an identified state, running with the owner for example, the same human signal may trigger the verbal doggy signal “I am so tired”.

Moreover, a state database and a signal database may be available for facilitating the associating 130 and the linking 160, respectively. In such a case, the method may support evolving and adaptive system. For that aim the method 200 may include the step of evolving 190 the state database and the signal database with accumulating experience of issuing signals reflecting the state of the carrier. For example, the owner may respond to an issued doggy signal of “it is fun to be outside” by a human signal “you are wrong”, and accordingly the state database is updated so that such an error is not reoccurring. In contrast, a human encouraging message like “that's right” may direct the system to enhance its signal in the current state. Thus, the method 200 supports an adaptive system guided by the owner.

In some embodiments, an issuable signal is selected in accordance with a specific human identity.

In some embodiments, the method 200 includes the step of receiving 180 programming inputs. Such programming inputs may be received manually by the owner pressing an appropriate button, or electronically using an appropriate interface in the device 80 and a computer having a HACOD programmer 65.

The method 200 may be performed by a program of instructions executable by a computerized apparatus. The program may be stored in a program storage device readable by the computerized apparatus. Exemplary storage devices are a compact disk and a flash memory unit.

Although the invention has been described in conjunction with specific embodiments thereof it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A device for issuing signals reflecting a state of an autonomous carrier, the carrier being autonomic in motion, the carrier carrying the device, the device comprising:
(a) one or more sensors adapted for sensing one or more parameters of the carrier and for issuing one or more outputs in accordance with the sensed parameters;
(b) one or more signal generators adapted for issuing signals sensible by humans; and
(c) a processor adapted for:
(i) receiving said one or more outputs;
(ii) triggering issue of one or more of said signals by said one or more signal generators in accordance with the received outputs.

2. The device of claim 1 wherein the carrier is autonomous in ground motion.

3. The device of claim 1 wherein the carrier is a pet animal.

4. The device of claim 1 wherein one sensor senses visible parameters of said animal.

5. The device of claim 1 wherein at least one sensor is one sensor of a group consisting:
(A) a global positioning system sensor;
(B) a tilt sensor;
(C) an acceleration meter; and
(D) a proximity sensing article.

6. The device of claim 1 wherein one sensor senses invisible parameters of said carrier.

7. The device of claim 1 wherein the carrier is a living carrier and one sensor is a sensor of a group consisting:
(A) a temperature meter adapted to measure the body temperature of said living carrier;
(B) a temperature meter adapted to measure the air temperature proximate to said living carrier;
(C) a respiration monitor of said living carrier;
(D) a pulse rate meter of said living carrier;
(E) a skin humidity sensor of said living carrier;
(F) a sniffer; and
(G) a blood pressure meter.

8. The device of claim 1 wherein certain state of said carrier is determined by at least one of:
(A) certain location of said carrier;
(B) certain posture of said carrier relative to ground; and
(C) having at least one invisible parameter within certain value range.

9. The device of claim 1 wherein one of the signal generators is a loudspeaker.

10. The device of claim 1 wherein one of the signal generators is a light source.

11. The device of claim 1 wherein the device further includes a voice recognition module.

12. The device of claim 1 wherein the device further includes a state database configured for containing a plurality of data items associated with determination of a state of said carrier.

13. The device of claim 1 wherein the device further includes a signal database configured for containing a plurality of signals, each signal is issuable by said one or more signal generators, the signal for certain case is determined in accordance with a state attributed to the carrier by the processor.

14. The device of claim 1 wherein the device further includes a button interface adapted for manual programming of the device.

15. The device of claim 1 wherein the device further includes a communication interface adapted for communicating with an external apparatus.

16. The device of claim 1 wherein the device is adapted to be programmed by an external agent.

17. A device for issuing signals reflecting a state of a living carrier, the living carrier carrying one or more sensors adapted for sensing one or more invisible parameters of said living carrier and for issuing one or more outputs in accordance with said one or more parameters, the device comprising a processor adapted for:
(i) receiving said one or more outputs;
(ii) associating a state of the carrier with said one or more outputs;
(iii) linking the associated state of the living carrier with a signal; and
(iv) triggering issue of the linked signal by one or more signal generators;
wherein said one or more signal generators are adapted for issuing a signal sensible by humans.

18. A method for issuing signals reflecting the state of an autonomous carrier, the carrier being autonomic in motion, the method comprising:
(a) receiving one or more outputs associated with one or more parameters of the carrier;
(b) triggering issue of one or more of said signals by said one or more signal generators in accordance with the received outputs.

19. The method of claim 18 wherein the step of triggering issue of one or more of said signals includes the actions of:
(i) associating a state of said carrier with said one or more outputs;
(ii) linking the associated state of the carrier with a signal; and
(iii) issuing the linked signal, the issued signal being sensible by human beings.

20. The method of claim 18 wherein the method further comprises the step of attaching an article to said carrier, said article including a device for issuing signals reflecting the state of said carrier.

21. The method of claim 18 wherein the method further comprises the steps of;
(e) receiving an audio human signal; and
(f) associating the received audio signal with a predetermined content item.

22. The method of claim 18 wherein an issuable signal is selected in accordance with a human vocal signal.

23. The method of claim 18 wherein the method further comprises the step of receiving programming inputs.

24. A program storage device readable by a computerized apparatus, tangibly embodying a program of instructions executable by the computerized apparatus to perform the method of claim 18.

25. The method of claim 19 wherein a state database and a signal database are available for facilitating said associating and said linking, respectively, and the method further comprises the step of evolving said state database and said signal database with accumulating experience of issuing signals reflecting the state of the carrier.
